(19) United States
(12) Patent Application Publication
(10) Pub. No.: US 2006/0227775 A1
(43) Pub. Date: Oct. 12, 2006

(54) System, method, and apparatus for embedding personal video recorder functions in transport packets

(76) Inventors: Arul Thangaraj, Bangalore (IN); Vijayanand Aralaguppe, Bangalore (IN)

Correspondence Address: MCANDREWS HELD & MALLOY, LTD, 500 WEST MADISON STREET, SUITE 3400, CHICAGO, IL, 60661, US

(21) Appl. No.: 11/103,819

(22) Filed: Apr. 12, 2005

(51) Int. Cl. H04L 12/56

(52) U.S. Cl. 370/389

(57) ABSTRACT

Described herein are system(s), method(s), and apparatus for embedding personal video recorder functions in transport packets. In one embodiment, there is described a method for commanding a video processor. The method comprises generating a transport packet; placing an indicator in the transport packet, said indicator indicating that the transport packet contains commands for the video processor; and placing commands in the transport packet. The transport packet comprises no more than 130 bytes.

### FEDERALLY SPONSORED RESEARCH OR DEVELOPMENT

[Not Applicable]

### [MICROFICHE/COPYRIGHT REFERENCE]

[Not Applicable]

### BACKGROUND OF THE INVENTION

Many systems that deal with digital video data, including the normal playback and trick mode playback of video data, are intrinsically tied to the proprietary system and platform on which they are operating. There have also been many standards developed in this particular area of technology concerning data types. In addition, there have been several standards into which data is formatted for transport.

One such transport standard is the DirecTV transport stream format (DirecTV TS). Many of the various data types are formatted into this format for communication between various components in a system.

In addition, although there has been some uniformity in the development of TS formats, there has nevertheless been a dependence on dedicated communication and control between components that control the playback (including trick mode playback) of the data and the device that performs the decoding of the data for playback. The control device and the decoding device may actually be in the same device, but there is nevertheless a great deal of dedicated interfacing that is required to perform the proper control of the data playback.

Further limitations and disadvantages of conventional and traditional systems will become apparent to one of skill in the art through comparison of such systems with the invention as set forth in the remainder of the present application with reference to the drawings.

### SUMMARY OF THE INVENTION

Described herein are system(s), method(s), and apparatus for embedding personal video recorder functions in transport packets substantially as shown in and/or described in connection with at least one of the figures, as set forth more completely in the claims.

These and other advantages and novel features of the present invention, as well as details of illustrated examples embodiments thereof, will be more fully understood from the following description and drawings.

### BRIEF DESCRIPTION OF THE DRAWINGS

FIG. 1 is a block diagram describing the encoding of video data in accordance with the MPEG-2 standard;

FIG. 2 is a block diagram describing an exemplary DirecTV transport packet;

FIG. 3 is a block diagram describing an exemplary circuit for decoding video data in accordance with an embodiment of the present invention;

FIG. 4 is a block diagram describing an exemplary command packet in accordance with an embodiment of the present invention;

FIG. 5 is a flow diagram for sending command packets in accordance with an embodiment of the present invention; and

FIG. 6 is a flow diagram for detecting command packets in accordance with an embodiment of the present invention.

### DETAILED DESCRIPTION OF THE INVENTION

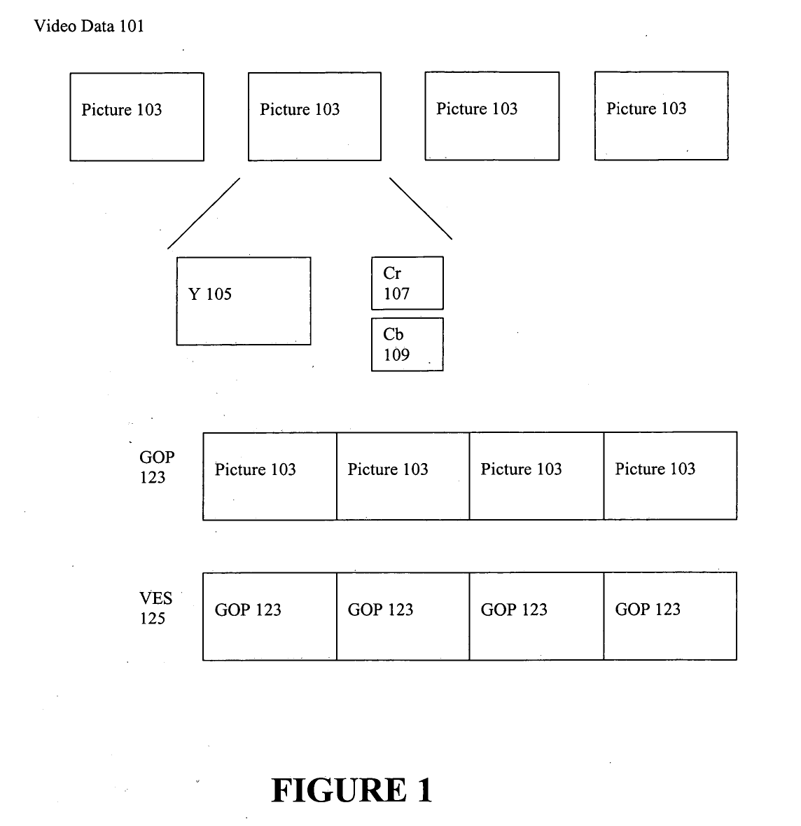

FIG. 1 illustrates a block diagram of an exemplary Moving Picture Experts Group (MPEG) encoding process of video data 101, in accordance with an embodiment of the present invention. The video data 101 comprises a series of pictures 103. Each picture 103 comprises two-dimensional grids of luminance Y, 105, chrominance red Cr, 107, and chrominance blue Cb, 109, pixels.

The pictures can be encoded using a variety of compression techniques that take advantage of both spatial and temporal redundancies. The pictures are grouped together as a group of pictures (GOP) 123. The GOP 123 also includes additional parameters further describing the GOP. Groups of pictures 123 are then grouped, forming what is known as a video elementary stream (VES) 125. The VES 125 is then packetized to form a packetized elementary sequence. The packetized video elementary stream is then further packetized into fixed-size transport packets.

The transport packets can be multiplexed with other transport packets carrying other content, such as another video elementary stream 125 or an audio elementary stream. The multiplexed transport packets form what is known as a transport stream. The transport stream is transmitted over a communication medium for decoding and displaying.

There are several types of transport packets, including MPEG Transport Packets, and DirecTV transport packets. The DirecTV transport packets are a proprietary format used for transmitting media via satellite.

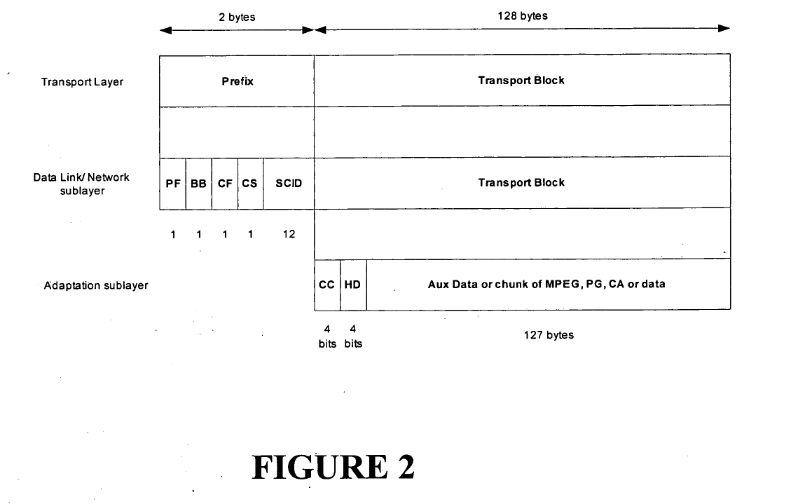

Referring now to FIG. 2, there is illustrated a block diagram describing an exemplary DirecTV transport packet 250. The DirecTV transport packet 250 comprises of 130 bytes. This includes a 2 byte prefix and 128 bytes of transport data.

The header includes a number of fields. These fields are described in the table below.

| Field Definition | Bit Width | Description |
|---|---|---|
| Packet Framing | 1 | This bit toggles between 0 and 1 |
| (PF) | | |
| Bundle Boundary | 1 | The decoder should ignore this |
| (BB) | | bit. |
| Control Flag | 1 | CF = 0 The transport packet is |
| (CF) | | scrambled |
| | | CF = 1 The transport packet is |
| | | not scrambled |
| Control Sync | 1 | For scrambled transport packet |
| (CS) | | this bit indicates the key to |
| | | be used for descrambling. |
| SCID | 12 | This field uniquely identifies |
| | | the application for which the |
| | | transport packet's transport |
| | | block is intended. The |
| | | following scid's are reserved |
| | | for specific purposes: |
| | | SCID = 0x0000 (Null packets) |
| | | SCID = 0xFEF-0xFF (Reserved) |
| Transport block | 128 * 8 | This is the application data |
| | | to be processed by the |
| | | application addressed by the |
| | | SCID. |

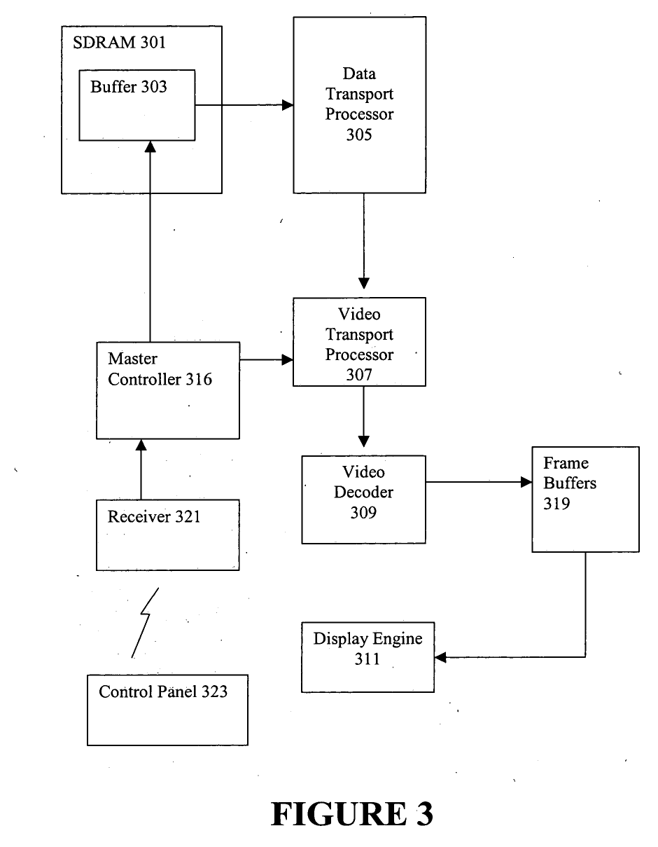

FIG. 3 illustrates a block diagram of an exemplary circuit for decoding the compressed video data, in accordance with an embodiment of the present invention. Data is received and stored in a buffer 303 within Synchronous Dynamic Random Access Memory (SDRAM) 301. The data can be received from either a communication channel, including a satellite communication link.

The data output from the presentation buffer 303 is then passed to a data transport processor 305. The data transport processor 205 demultiplexes the transport stream, and passes the audio transport stream to an audio decoder 315 and the video transport stream to a video transport processor 307 and then to a video decoder 209. The audio data is then sent to the output blocks, and the video is sent to a display engine 311.

The display engine 311 scales the video picture, renders the graphics, and constructs the complete display. Once the display is ready to be presented, it is passed to a video encoder where it is converted to analog video using an internal digital to analog converter (DAC). The digital audio is converted to analog in an audio DAC 317.

The decoder 309 decodes at least one picture 103, during each frame display period, in the absence of Personal Video Recording (PVR) modes when live decoding is turned on. Due to the presence of the bi-directionally coded pictures, the decoder 309 may decode the pictures 103 in an order that is different from the display order. The decoder 309 writes the decoded pictures 103 to frame buffers 319.

The display engine 311, then displays the decoded images onto a display device, e.g. monitor, television screen, etc. The display engine 311 displays the decoded pictures 103 in the display order. The frame buffers 319 allow for reordering from the decode order to the display order. The data transport processor 305, the video transport processor 307 decoder 309, the display engine 311, and audio decoder 315 can be slave modules controlled by a master controller 316.

The circuit also supports personal video recording functions, such as fast forward, rewind, and pause, to name a few. The circuit includes a receiver 321 for receiving a signal from a control panel 323. The control panel can comprise a variety of input devices, such as a hand-held infrared or radio remote control unit, or a keyboard. The control panel 323 can either form a portion of the circuit or be separate from the circuit.

The user can initiate personal video recording functions from the control panel. The control panel 323 provides a signal corresponding to the particular personal video recording function to the controller 316 via receiver 321. Responsive thereto, the controller 316 generates DirecTV transport packet formatted commands (now referred to as command packets) that effectuate the personal video recording function selected by the user. The controller 216 transmits the DirecTV transport packets to the video transport processor 307.

The controller 316 can transmit the DirecTV transport packets to the video transport processor 307 in a number of ways. According to certain embodiments, the controller 316 can directly transmit the DirecTV transport packet to the video transport processor 307. In another embodiment, the controller 316 can write the DirecTV transport packet to the buffer 303. The video transport processor 307 detects the command packets and performs the commands.

According to certain embodiments of the present invention, the command packets can include an indicator in one of the fields, indicating that the DirecTV transport packet is a command packet. According to another embodiment of the present invention, the 128 payload 250b can commence with a code indicating that the DirecTV transport packet is a command packet.

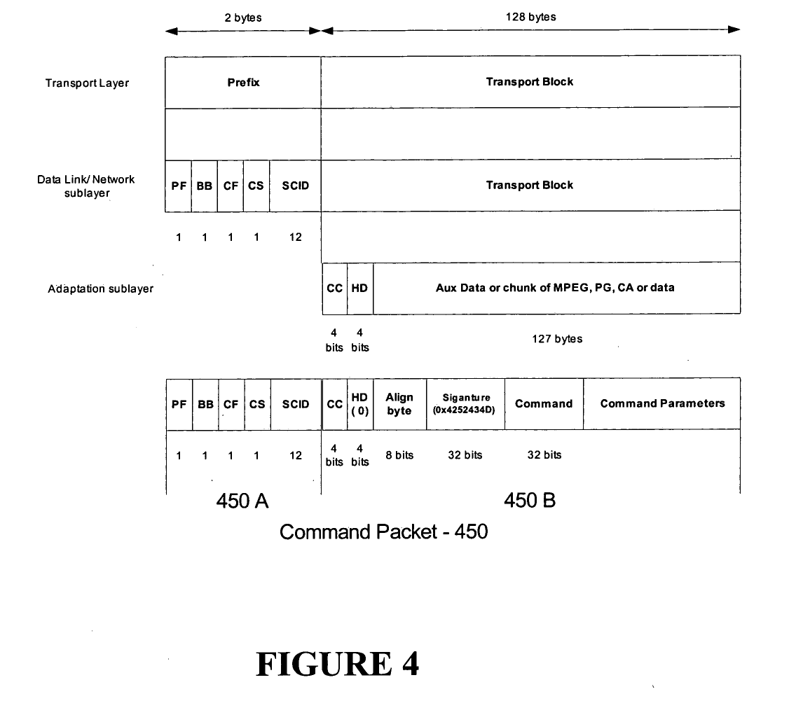

Referring now to FIG. 4, there is illustrated a block diagram describing an exemplary command packet. The packet comprises of 2 bytes of prefix and 128 bytes of Transport block. The transport block consists of 4 bits of CC field and 4 bits of HD field. The remaining data corresponds to command.

According to certain aspects of present invention, the controller 316 set certain bytes in the transport block to a values indicating that the DirecTV transport packet 50 is a command packet. The table given below is an example of a DirecTV transport packet containing Trick mode command fields or referred as DirecTV command packet.

| | Bit | |
|---|---|---|
| Field Definition | Width | Value |
| Packet Framing (PF) | 1 | 0/1 |
| Bundle Boundary (BB) | 1 | X |
| Control Flag (CF) | 1 | 1 |
| Control Sync (CS) | 1 | 0 |
| SCID | 12 | Video PID |
| Continuity Counter (CC) | 4 | XXXXb |
| Header Designator | 4 | 0 |
| Alignment Byte | 8 | 0 |
| Signature | 32 | 4252434Dh |
| Command | 32 | |
| Command Parameters | Various | |

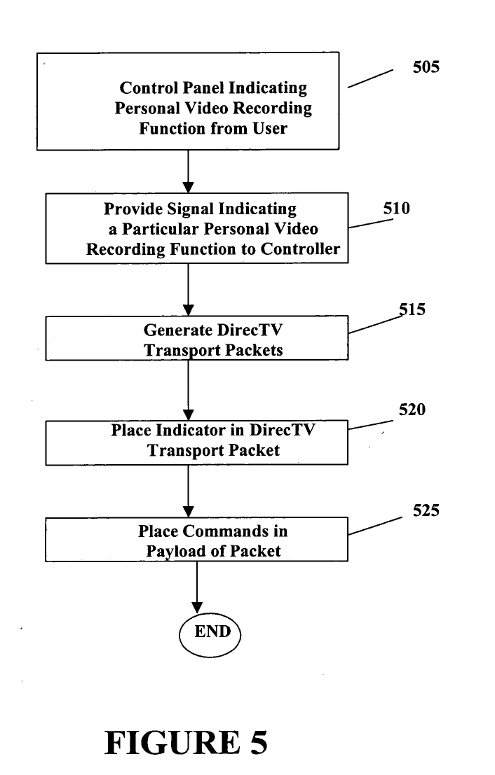

Referring now to FIG. 5, there is illustrated a flow diagram for issuing trick mode commands using DirecTV transport packets in accordance with an embodiment of the present invention. At 505, the receiver 321 receives a signal from the control panel 323 indicating a particular personal video recording function from the user. Responsive thereto, at 510 the receiver provides a signal indicating the particular personal video recording function to the controller 316.

Responsive thereto, the controller 316 generates one or more DirecTV transport packets 450 for transmitting commands that effectuate the particular personal video recording function selected by the user at 515.

At 520, the controller 316 places an indicator in the DirecTV transport packet 450, indicating that the DirecTV transport packet 450 is a command packet. The controller 316 can either place the indicator in the DirecTV transport packet 450, by either setting a particular field, of the transport block to particular value. At 525, the controller 316 places commands in the payload, of the command packet. The controller 216 then provides the command packet to the video transport processor 307, either directly or by writing the command packet to the buffer 303.

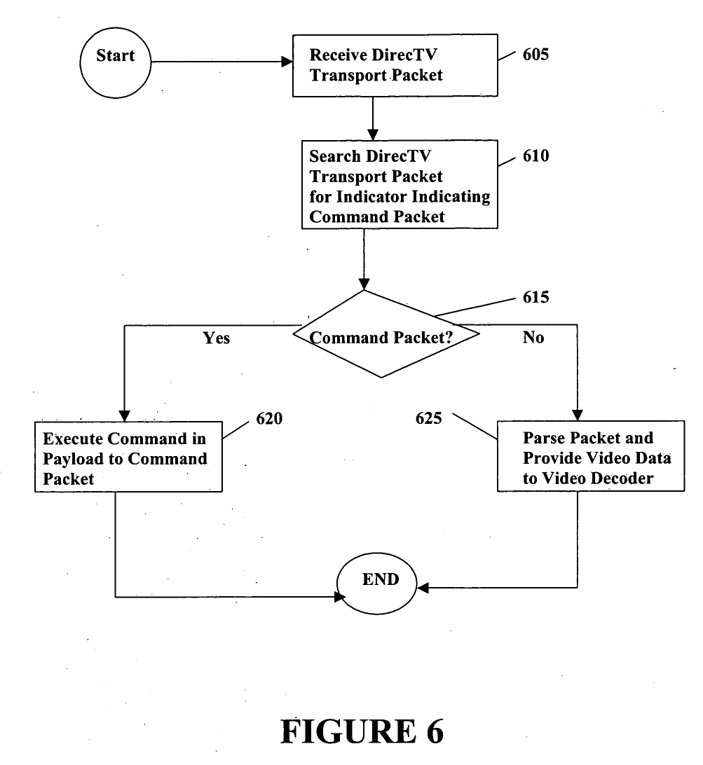

Referring now to FIG. 6, there is illustrated a flow diagram for executing commands from the command packets, in accordance with an embodiment of the present invention. At 605, the video transport processor 307 receives a DirecTV transport packet 450.

At 610, the video transport processor 307 searches the DirecTV transport packet 450 received during 605 for an indicator indicating that the DirecTV transport packet 450 is a command packet to determine whether the DirecTV transport packet 450 is a command packet at 615.

According to certain aspects of the present invention, the video transport processor 307 searches a particular field, for a particular value indicating that DirecTV transport packet, e.g., 450 is command packet.

If at 620, the video transport processor 307 determines that the DirecTV transport packet 450 is a command packet, the video transport processor 307 executes the commands in the payload 450b of the command packet. If at 615, the video transport processor 307 determines that the DirecTV transport packet 450 is not a command packet, the video transport processor 307 parses (at 625) the packet and provides the video data contained therein to the video decoder 309.

The embodiments described herein may be implemented as a board level product, as a single chip, application specific integrated circuit (ASIC), or with varying levels of the decoder system integrated with other portions of the system as separate components. The degree of integration of the decoder system will primarily be determined by the speed and cost considerations. Because of the sophisticated nature of modern processor, it is possible to utilize a commercially available processor, which may be implemented external to an ASIC implementation. Alternatively, if the processor is available as an ASIC core or logic block, then the commercially available processor can be implemented as part of an ASIC device wherein certain functions can be implemented in firmware. In one embodiment, the present invention can comprise an integrated circuit.

While the invention has been described with reference to certain embodiments, it will be understood by those skilled in the art that various changes may be made and equivalents may be substituted without departing from the scope of the invention.

In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for commanding a video processor, said method comprising:
generating a transport packet;
placing an indicator in the transport packet, said indicator indicating that the transport packet contains commands for the video processor; and
placing commands in the transport packet; and
wherein the transport packet comprises no more than 130 bytes.3. The method of claim 1, wherein the transport packet comprises a payload, and wherein placing the indicator in the transport packet further comprises:
setting particular bytes of the payload to a particular value, said value indicating that the transport packet contains commands for the video processor.

2. The method of claim 1, wherein the transport packet comprises a payload, and wherein placing the commands in the transport packet further comprises placing commands in the payload.

3. The method of claim 1, further comprising:
receiving a signal indicating a user selection; and
wherein placing the commands in the transport packet further comprises:
placing commands in the transport packet corresponding to the user selection.

4. The method of claim 1, wherein the transport packet comprises a DirecTV transport packet.

5. A method for executing commands, said method comprising:
receiving a transport packet, said transport packet comprising no more than 130 bytes;
examining the transport packet for an indicator, said indicator indicating that the transport packet contains commands; and
wherein the transport packet includes the indicator, executing commands from the transport packet.

6. The method of claim 5, wherein the transport packet comprises a payload, and wherein examining the transport packet for the indicator further comprises:
examining particular bytes of the payload for a particular value, said value indicating that the transport packet contains commands for the video processor.

7. The method of claim 5, wherein the transport packet comprises a payload, and wherein the executing the commands from the transport packet further comprises executing commands from the payload.

8. The method of claim 5, further comprising:
providing video data to a video decoder if the transport packet does not include the indicator.

9. The method of claim 5, wherein the transport packet further comprises a DirecTV transport packet.

10. The method of claim 5, wherein the commands correspond to a user selection.

11. A system for performing video functions, said system comprising:
a controller for generating a transport packet with commands corresponding to a particular one of the video functions, said transport packet comprising no more than 130 bytes; and
a processor for executing the commands.

12. The system of claim 11, further comprising:
a receiver for receiving a user input, said user input corresponding to the particular one of the video functions, and providing a signal indicating the particular one of the video functions to the controller.

13. The system of claim 11, wherein the controller inserts an indicator into the transport packet, said indicator indicating that the transport packet contains commands.

14. The system of claim 13, wherein the transport packet comprises a payload, and wherein the controller sets particular bytes of the payload to a particular value.

15. The system of claim 11, wherein the transport packet comprises a payload, and wherein the controller writes the commands into the payload.

16. The system of claim 11, wherein the transport packet comprises a DirecTV transport packet.

17. The system of claim 11, further comprising:
a buffer for storing the transport packet.

18. The system of claim 11, wherein the processor receives a plurality of transport packets, examines each of the plurality of transport packets for an indicator, said indicator indicating that the transport packet contains commands, and executing commands from the ones of the plurality of transport packets that include the indicator.

19. The system of claim 18, wherein each of the transport packets comprises a payload, and wherein the controller examines particular bytes of the payload in each of the transport packets.

20. The system of claim 18, further comprising:
providing video data to a video decoder from the ones of the plurality of transport packets that do not include the indicator.

21. A circuit for commanding a video processor, said circuit comprising:
a controller; and
a memory connected to the controller, said memory storing instructions executable by the controller, wherein execution of the instructions by the controller causes:
generating a transport packet;
placing an indicator in the transport packet, said indicator indicating that the transport packet contains commands for the video processor; and
placing commands in the transport packet; and
wherein the transport packet comprises no more than 180 bytes.

22. The circuit of claim 21, wherein the transport packet comprises a payload, and wherein placing the indicator in the transport packet further comprises:
setting particular bytes of the payload to a particular value, said value indicating that the transport packet contains commands for the video processor.

23. The circuit of claim 21, wherein the transport packet comprises a payload, and wherein placing the commands in the transport packet further comprises placing commands in the payload.

24. The circuit of claim 21, wherein execution of the instructions by the controller also causes receiving a signal indicating a user selection; and wherein placing the commands in the transport packet further comprises placing commands in the transport packet corresponding to the user selection.

25. The circuit of claim 21, wherein the transport packet comprises a DirecTV transport packet.
